(19) United States
(12) Patent Application Publication
(10) Pub. No.: US 2005/0029348 A1
(43) Pub. Date: Feb. 10, 2005

(54) Memory card reader with a chamber for receiving memory card(s)

(76) Inventor: Robert Tsao, Taipei (TW)

Correspondence Address: Leong C. LEI, PMB#1008, 1867 Ygnacio Valley Rd., Walnut Creek, CA, 94598-3214, US

(21) Appl. No.: 10/632,846

(22) Filed: Aug. 4, 2003

(51) Int. Cl. G06K 7/00; G06K 7/06

(52) U.S. Cl. 235/439; 235/441

(57) ABSTRACT

A memory card reader which has a housing having at least a slot for receiving a memory card, wherein the housing is formed with a chamber for receiving at least a memory card, the chamber being provided with a cover adapted to be engageable with the chamber thereby enabling the chamber to be opened or closed as required, whereby no additional space is required for carrying a container for receiving memory cards, the memory card can be prevented from losing or being damaged, and an additional value can be yielded to the memory card reader.

### BACKGROUND OF THE INVENTION

1. Field of the Invention

This invention is related to a memory card memory reader, and in particular to one having a chamber for receiving one or more memory cards.

2. Description of the Prior Art

With the maturity of the photograph treatment technology for digital cameras, the resolution quality of the photograph taken by digital cameras is almost the same as that of conventional cameras and so more and more people are using digital cameras. However, if a person wants to use a digital camera while traveling, she or he must also carry a memory card reader in order to be able to output photographs to a television or to print them out. Further, the memory capacity required for a photograph increases as greater resolution is required, and so the memory card fitted in a digital camera is generally insufficient, thereby making it necessary for a user to bring at least an additional memory card for spare use. Furthermore, the user must carry a container for storing the additional memory card or the memory card taken out of the digital camera; otherwise, she or he must put it in a traveling bag or the like, thus causing much inconvenience in use. Moreover, the memory card is small in size and can easily be lost and damaged.

Therefore, it is an object of the present invention to provide a memory card reader with a chamber which can obviate and mitigate the above-mentioned drawbacks.

### SUMMARY OF THE INVENTION

This invention is related to a memory card memory reader having a chamber for receiving one or more memory cards.

It is the primary object of the present invention to provide a memory card reader which has a housing having at least a slot for receiving a memory card, wherein the housing is formed with a chamber for receiving at least a memory card, the chamber being provided with a cover adapted to be engageable with the chamber thereby enabling the chamber to be opened or closed as required, whereby no additional space is required for carrying a container for receiving memory cards, the memory card can be prevented from losing or being damaged, and an additional value can be yielded to the memory card reader.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention;

FIG. 2 is a perspective view of the present invention

FIG. 3 is a perspective view of the present invention, with a memory card disposed in the chamber.

FIG. 4 is a left side elevational view of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

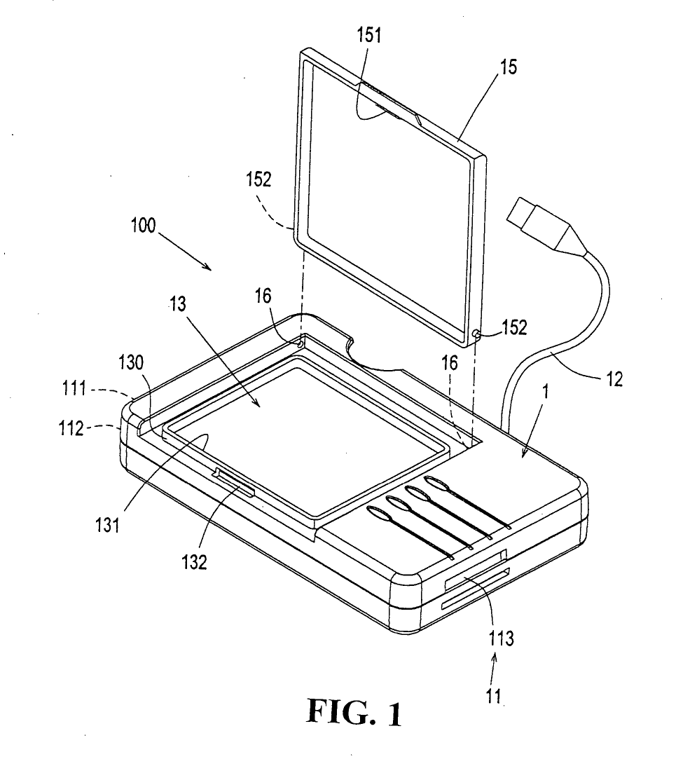

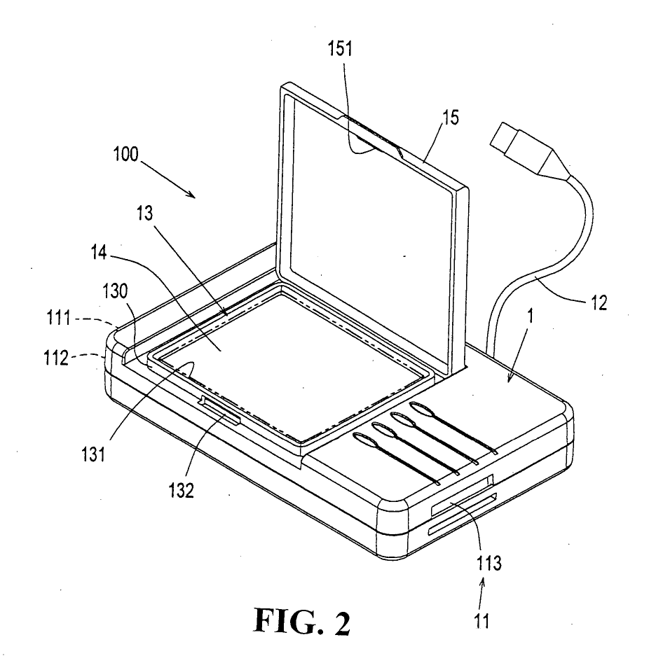

With reference to the drawings and in particular to FIGS. 1 and 2 thereof, the card reader 100 according to the present invention comprises a housing 1 formed with at least a card slot 11. In this preferred embodiment, the housing 1 is further formed with three additional slots, i.e. a slot 111 for compact flash cards, a slot 112 for smart memory cards, and a slot 113 for secure digital cards. The card reader 100 is connected to a terminal (not shown) such as a personal computer, a color printer, a video apparatus or the like wirelessly or via a cable 12.

However, it should be noted that the number and the type of the slot 11 are not limited to the preferred embodiment described above, since it will be understood that various omissions, modifications, substitutions and changes in the forms and details of the device illustrated and in its operation can be made by those skilled in the art.

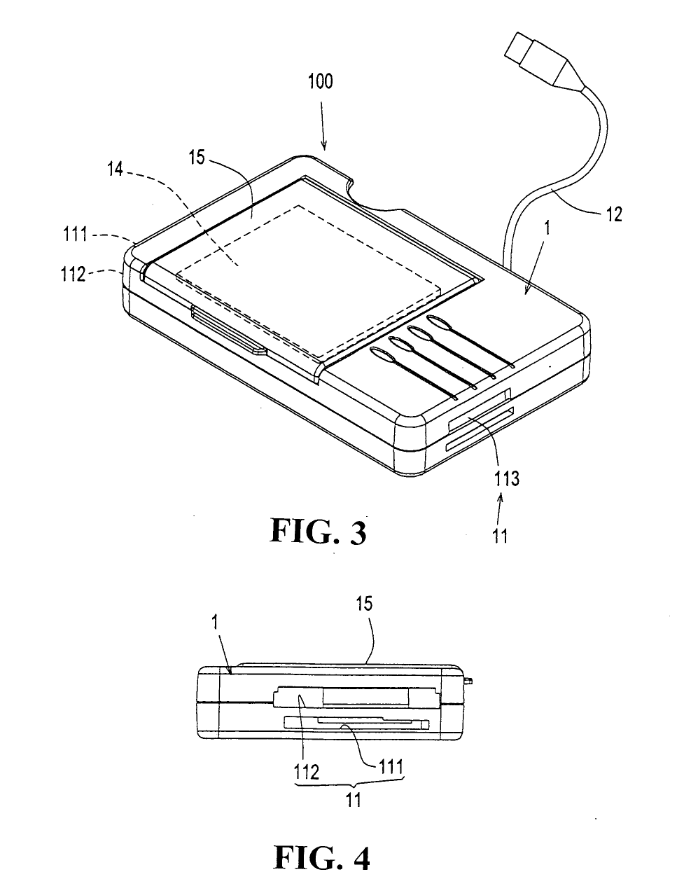

The card reader 100 according to the present invention is characterized by a chamber 13 which is formed on the top of the card reader 100 and designed to receive at least a memory card 14 (see FIGS. 2, 3 and 4). The top 131 of the chamber 13 is engaged with a cover 15 so that the chamber 13 can be opened or closed with the cover 15. As a consequence, the user can use the chamber 13 on the top of the card reader 100 to store one or more memory cards.

As shown in FIG. 1, a frame 130 is mounted in the chamber 13 and formed at outer side with a recess 132, and the cover 15 has a protuberance 151 at the front side which is configured to be engageable with the recess 132 thereby enabling the cover 15 to be kept closed on the frame 130.

The chamber 13 is formed with two aligned holes 16, and the cover 15 has two aligned pins 152 at two opposite outer sides thereof adapted to be pivotally connected with the aligned holes 152, so that the cover 15 can be turned open or closed with respect to the chamber 13.

The present invention resides in a memory card reader formed with a chamber on the top thereof, so that when a user carries a memory card reader according to the present invention, the user also carries a space for storing one or more memory cards thereby making it unnecessary for the user to carry a container for storing memory cards. As a result, the spare memory card or the memory card removed by a digital camera can be conveniently stored in the chamber of the present invention. Accordingly, the present invention has the following advantages:
a. The chamber for receiving memory cards is formed on the memory card reader, so that the memory card reader has two purposes and no additional space is required for carrying a container for receiving memory cards.
b. The present invention can prevent the memory card from losing or being damaged.
c. It is no longer necessary to carry an additional container for storing memory cards when carrying a digital camera.
d. The present invention is simple in construction and provides an additional value to a memory card reader.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A memory card reader comprising a housing which has at least a slot for receiving a memory card, wherein said housing is formed with a chamber for receiving at least a memory card, said chamber being provided with a cover adapted to be engageable with said chamber thereby enabling said chamber to be opened or closed as required.

2. The memory card reader as claimed in claim 1, further comprising a frame mounted on said chamber and formed with a recess, said cover having a side formed with a protuberance which is configured to be engageable with said recess thereby enabling said cover to be kept closed on said frame as required.

3. The memory card reader as claimed in claim 1, wherein said chamber is formed with two aligned holes, and said cover has two aligned pins at two opposite outer sides thereof adapted to be pivotally connected with said aligned holes.

4. The memory card reader as claimed in claim 1, wherein said housing has additional slots for receiving compact flash cards, smart memory cards and secure digital cards.
